(19) United States
(12) Patent Application Publication
(10) Pub. No.: US 2015/0337989 A1
(43) Pub. Date: Nov. 26, 2015

(54) Pipe Support

(71) Applicant: Luke Bolton, Surrey Hills (AU)

(72) Inventor: Luke Bolton, Surrey Hills (AU)

(21) Appl. No.: 14/290,495

(22) Filed: May 29, 2014

(30) Foreign Application Priority Data
May 20, 2014 (AU) 2014202762

(51) Int. Cl. F16L 3/04; F16M 13/02; F16L 3/10

(52) U.S. Cl. CPC F16L 3/04; F16L 3/10; F16M 13/02

(57) ABSTRACT

A saddle or clip for holding conduit is usable with a plurality of conduit sizes. In specific structures, the saddle or clip includes a tongue, preferably a resilient tongue, biased against one side of the clip. In use, the tongue moves outward to accommodate conduits or pipes of different diameters.

### BACKGROUND OF THE INVENTION

The present invention relates to a clip or saddle and, more particularly, to a clip or saddle used to attach conduit or pipe to a surface.

A saddle, also known as a pipe support or pex clip, is a device used in the plumbing and gas fitting industries to clasp conduit that can then be attached to a surface. Some saddles come preloaded with a nail or screw for attaching to a surface, or have an aperture for a fixing device. Saddles are used to attach conduit to surfaces such as timber, steel, polystyrene, concrete, brick or other masonry that may be used in the construction industry.

Prior art saddles, particularly those made of polypropylene, enable only one size of pipe to be clasped. This means that the tradesperson is obliged to stock and carry varying sizes of said devices to cater for the varying diameters of pipe. This takes up more space in the tradesperson's nail bag and may mean that the tradesperson wastes time looking for the correct size clip.

It is an object of the present invention to overcome, or at least alleviate, one or more of the difficulties or deficiencies associated with the prior art.

### SUMMARY OF THE INVENTION

The present invention provides a clip for holding conduit or pipe. The clip includes one or more tongues biased against one side of the clip that, in use, move outward to accommodate different diameters of conduit. The tongues are preferably made from a resilient material.

In some embodiments, the clip is approximately “u” shaped in external cross section and includes one or more resilient tongues. One side of the clip is suitably relatively fixed (i.e. constant in shape when in use) and includes an aperture for a fixing device. The aperture may be approximately parallel with the relatively fixed side of the clip, and may suitably be tapered through its vertical height, such that the diameter of the aperture at the entrance point for the fixing device is larger than the diameter at the exit point. Such an aperture may have a recessed entrance point such that, in use, the fixing device sits flush with the surface of the clip once it is fixed into position. The aperture and the one or more resilient tongues are suitably located on the opposite sides of the clip, and the one or more resilient tongues may project from the bowl or base of the “u” shaped clip into the central space of the “u” shaped clip.

### BRIEF DESCRIPTION OF THE DRAWINGS

FIG. 1 shows a front elevation of a clip according to the present invention.

FIG. 2 shows side elevation of a clip according to the present invention, from the tongue side of the clip.

FIG. 3 shows a plan view of a clip according to the present invention.

FIG. 4 is a drawing of a clip according to the present invention, demonstrating the ‘arm within an arm’ arrangement.

FIG. 5 is a drawing of the clip in use.

FIG. 6 shows an alternative embodiment of the clip of the invention with two tongues situated within one another.

FIG. 7 shows an alternative embodiment of the clip of the invention with two tongues adjacent to one another.

FIG. 8 is a front elevation of the clip of FIG. 7.

FIG. 9 is a side elevation of the clip of FIG. 7.

### DETAILED DESCRIPTION OF THE INVENTION

The present invention provides a saddle or clip that caters for a plurality of conduit sizes.

In a preferred embodiment of the present invention, the saddle or clip includes a tongue biased against one side of the clip. In use, tongue the moves outward to accommodate conduits or pipes of different diameters.

In a preferred embodiment, the tongue is a resilient tongue.

In another preferred embodiment, the saddle or clip is approximately “u” shaped in external cross section. In a particularly preferred embodiment, the internal cross section is approximately a major arc of a circle.

In another preferred embodiment, one side of the “u” shaped clip contains an aperture for a fixing device, such as a nail or screw. In a particularly preferred embodiment, the aperture is parallel with the longitudinal axis of that side of the “u” shaped clip.

In another preferred embodiment, one side of the “u” shaped clip, preferably the opposite side to that containing the aperture for the fixing device, includes a tongue, preferably a resilient tongue, that is biased against that side of the clip. In use, the resilient tongue moves outward to accommodate conduits or pipes of different diameters. By “outward” is meant that the resilient tongue moves away from the opposite side of the “u” shaped clip.

In a particularly preferred embodiment, the tongue projects from the bowl or base of the “u” shaped clip into the central space of the “u” shaped clip. In a particularly preferred embodiment, the tongue has an arc shape and approximately follows the same contour as the side of the “u” shaped clip. In use, one end of the tongue may be fixed at the base of the “u” shaped clip and the other end may flex away from the opposite side of the “u” shaped clip to accommodate conduits or pipes of wider diameters.

In another preferred embodiment, the tongue, preferably a resilient tongue, is formed in the side of the “u” shaped clip by two longitudinal slots, each approximately parallel to the side of the “u” shaped clip and a third slot extending between the two longitudinal slots at one end. The resilient tongue is preferably formed from the material inside these slots and extends from the “u” shaped clip at the other end of the two longitudinal slots at the base of the “u” shaped clip. The material surrounding the two longitudinal slots and the third slot preferably forms a frame around the tongue, with the tongue projecting inward into the central space of the “u” shaped clip. In use, the tongue moves outward from the central space to accommodate pipes of wider and wider diameter, until it is flush with this frame. In a preferred embodiment the frame may also be resilient, such that it may flex away from the other side of the “u” shaped clip.

In a particularly preferred embodiment, the tongue and the frame are each arc shaped in cross section, with the tongue forming a tighter arc and the frame forming a wider arc relative to the other side of the “u” shaped clip. Put another way, the tongue encroaches upon the central space of the “u” shaped clip to a greater extent than the frame.

In use, this “arm within an arm” arrangement enables conduits or pipes of varying diameter to be gripped in the central space of the “u” shaped clip. A narrower pipe, for example a 16 mm PEX pipe, may be gripped when the tongue is approximately in its resting position and a wider pipe, for example a 20 mm PEX pipe, may be gripped by pressing it into the central space, whereby the tongue flexes away from the central space until it is approximately flush with the frame, to accommodate the wider pipe. An even wider pipe may be accommodated by the tongue and frame both flexing away from the central space as the pipe is inserted.

Put another way, in use, if a smaller diameter conduit is to be used, the tongue flexes away from the central space allowing the conduit to enter this space then be held in place by the tongue and the other side of the ‘u’ shaped clip. If a larger diameter conduit is to be used, both the frame and the tongue flex to enable the conduit to enter the central space, with the tongue remaining relatively extended and the frame coming back into approximately its original position to hold the conduit in place.

In another preferred embodiment the bracket or clip may have more than one tongue, preferably more than one resilient tongue, on the flexible side of the “u” shaped clip, whereby each tongue is within or framed by the other. In another preferred embodiment the tongues may be arranged side by side. Preferably the tongues encroach into the central space of the “u” shaped clip to different extents, thereby forming different sized arcs relative to the other side of the “u” shaped clip. In this way, the bracket or clip may be designed to accommodate different diameters of conduit.

In a preferred embodiment the device may be made of a polypropylene that is firm but has a capability of some flexibility.

In a preferred embodiment, the bracket or clip may be moulded in a single piece (excluding the fixing device).

In a preferred embodiment, the bracket or clip may have external dimensions of approximately 30 mm×23 mm×18 mm, but these dimensions may vary according to the diameter of the conduit to be held and these dimensions are not given to be restrictive.

The fixing device may be a nail or screw and the aperture accepting the fixing device is preferably tapered, preferably uniformly, through its vertical height, such that the diameter of the circular aperture at the entrance point for the fixing device is larger than the diameter at the exit point. In use, this enables the fixing device to be held firmly in the aperture until it is hammered or screwed into the surface to which it is attached. In a preferred embodiment, the aperture may have an internal thread when a screw is being used as the fixing device. The aperture also preferably has a recessed entrance point such that, in use, the fixing device sits flush with the surface of the bracket or clip once it is hammered or screwed into position.

In a preferred embodiment both sides of the “u” shaped bracket or clip have a flat end so that, in use, the device neatly apposes the flat surface it is joined to by the fixing device.

In a preferred embodiment, the end of the tongue may be bevelled or flanged so that it is more readily accepting of the conduit. Similarly, the end of the frame adjacent the third slot may preferably be bevelled or flanged such that it is more readily accepting of the conduit. Similarly, the side of the “u” shaped clip containing the aperture for a fixing device may have a bevelled or flanged end so that it is more readily accepting of the conduit.

In another preferred embodiment, the material the device is made from may be of any colour and in a more preferred embodiment different sizes could be represented in correspondingly recognizable colours.

The present invention may be better understood with reference to the illustrations of its preferred embodiments. It should be understood, however, that the following description is illustrative only and should not be taken in any way as a restriction upon the generality of the invention described above.

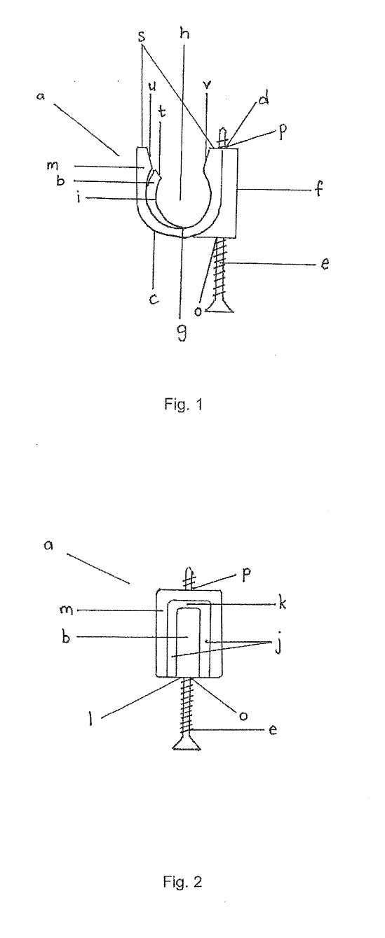

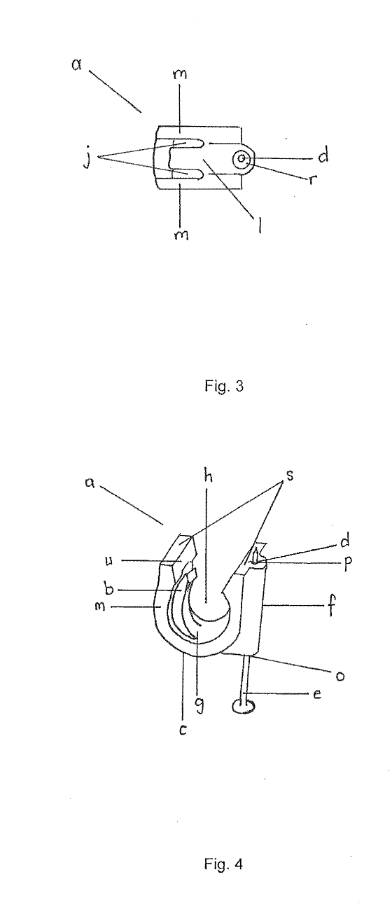

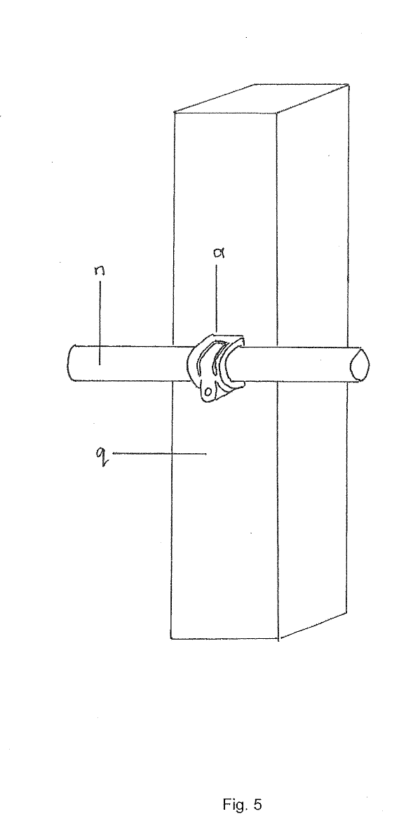

In one embodiment (FIGS. 1-4), a clip according to the present invention (a) includes a resilient tongue (b) that, in use, moves outward to accommodate conduits or pipes of different diameters. The clip is approximately “u” shaped (c) in external cross section. One side of the “u” shaped clip contains an aperture (d) for a fixing device (e), such as a nail or screw. The aperture is parallel with the longitudinal axis of that side of the “u” shaped clip (f).

The opposite side of the “u” shaped clip includes the resilient tongue (b). The resilient tongue projects from the bowl or base of the “u” shaped clip (g) into the central space of the “u” shaped clip (h). The tongue has an arc shape and approximately follows the same contour as the side of the “u” shaped clip (i).

The resilient tongue is formed in the side of the “u” shaped clip by two longitudinal slots (j), each approximately parallel to the side of the “u” shaped clip and a third slot (k) extending between the two longitudinal slots at one end and contiguous with them. The resilient tongue is formed from the material inside these slots and extends from the “u” shaped clip at the other end of the two longitudinal slots (l). The material surrounding the two longitudinal slots and the third slot preferably forms a frame (m) around the resilient tongue, with the resilient tongue projecting inward into the central space of the “u” shaped clip (h). In use, the resilient tongue moves outward from the central space to accommodate pipes of wider and wider diameter, until it is flush with this frame (m). In a preferred embodiment the frame (m) may also be resilient, such that it may flex away from the other side of the “u” shaped clip (f).

The resilient tongue (b) and the frame (m) are each arc shaped in cross section, with the resilient tongue forming a tighter arc and the frame forming a wider arc relative to the other side of the “u” shaped clip (f). Put another way, the resilient tongue encroaches upon the central space (h) of the “u” shaped clip to a greater extent than the frame.

In use (FIG. 5), the “arm within an arm” arrangement enables conduits or pipes (n) of varying diameter to be gripped in the central space of the “u” shaped clip (a).

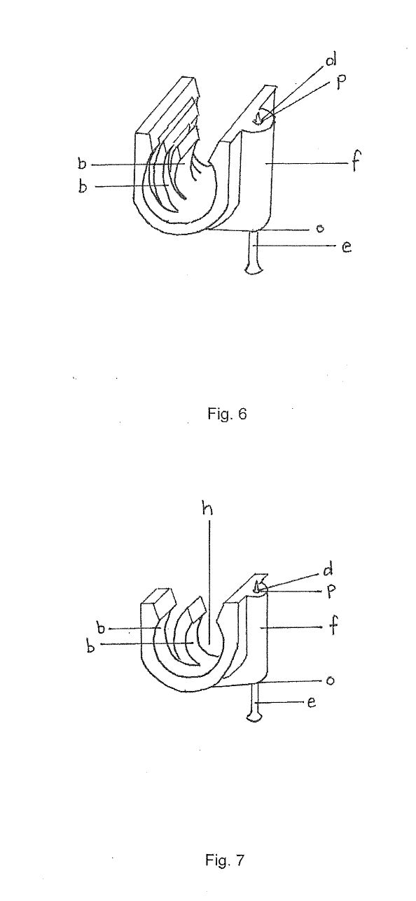

In another embodiment (FIG. 6) the bracket or clip may have more than one resilient tongue (b) on the flexible side of the “u” shaped clip, whereby each resilient tongue is within or framed by the other.

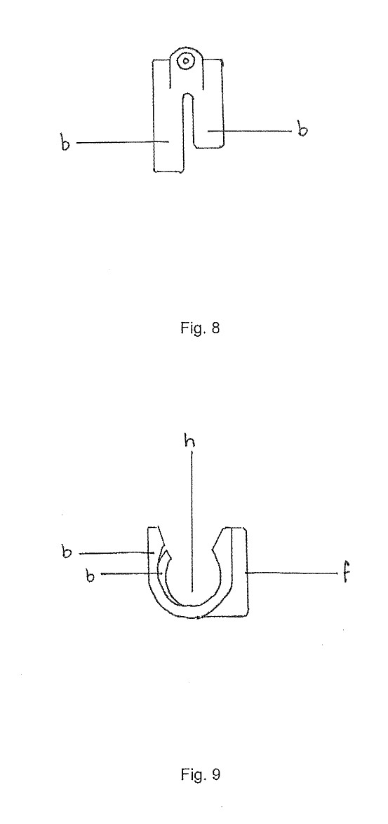

In another embodiment (FIGS. 7-9) the resilient tongues (b) may be arranged side by side. The resilient tongues encroach into the central space (h) of the “u” shaped clip to different extents, thereby forming different sized arcs relative to the other side (f) of the “u” shaped clip. In this way, the bracket or clip may be designed to accommodate different diameters of conduit.

The fixing device (e) may be a nail or screw and the aperture accepting the fixing device is preferably tapered, preferably uniformly, through its vertical height, such that the diameter of the circular aperture at the entrance point for the fixing device (o) is larger than the diameter at the exit point (p). In use, this enables the fixing device to be held firmly in the aperture until it is hammered or screwed into the surface to which it is attached (q). The aperture may have an internal thread when a screw is being used as the fixing device. The aperture also preferably has a recessed entrance point (r) such that, in use, the fixing device sits flush with the surface of the bracket or clip once it is hammered or screwed into position.

Both sides of the “u” shaped bracket or clip have a flat end (s) so that, in use, the device neatly apposes the flat surface (q) it is joined to by the fixing device (e).

The end of the resilient tongue may be bevelled or flanged (t) so that it is more readily accepting of the conduit. Similarly, the end of the frame adjacent the third slot may preferably be bevelled or flanged (u) such that it is more readily accepting of the conduit. Similarly, the side of the “u” shaped clip containing the aperture for a fixing device may have a bevelled or flanged end (v) so that it is more readily accepting of the conduit.

Finally, it is to be understood that various alterations, modifications and/or additions may be made without departing from the spirit of the present invention as outlined herein.

1. A clip for holding conduit or pipe, said clip including a resilient tongue that, in use, moves outward to accommodate different diameters of conduit, wherein the clip is approximately “u” shaped in external cross section, wherein one side of the clip is relatively fixed and includes an aperture for a fixing device, the aperture being approximately parallel with a longitudinal axis of the relatively fixed side of the “u” shaped clip, wherein the resilient tongue is formed in a side of the “u” shaped clip opposite to the relatively fixed side by two longitudinal slots, each approximately parallel to the side of the “u” shaped clip, and a third slot extending between the two longitudinal slots at one end, and wherein the resilient tongue projects from a bowl or base of the “u” shaped clip into a central space of the “u” shaped clip.

2. (canceled)

3. (canceled)

4. (canceled)

5. A clip according to claim 1, wherein the aperture is tapered through its vertical height, such that a diameter of the aperture at an entrance point for the fixing device is larger than a diameter at an exit point for the fixing device.

6. A clip according to claim 5, wherein the aperture has a recessed entrance point such that, in use, the fixing device sits flush with a surface of the clip once it is fixed into position.

7. (canceled)

8. (canceled)

9. (canceled)

10. (canceled)

11. A clip according to claim 1, wherein material surrounding the two longitudinal slots and the third slot forms a frame around the resilient tongue.

12. A clip according to claim 11, wherein the resilient tongue and the frame are each arc shaped in cross section, with the resilient tongue forming a tighter arc and the frame forming a wider arc relative to the relatively fixed side of the “u” shaped clip.

13. (canceled)

14. (canceled)

15. A clip according to claim 1, wherein an end of the resilient tongue is bevelled.

16. A clip according to claim 15, wherein an end of the frame adjacent the third slot is bevelled.

17. A clip according to claim 16, wherein the relatively fixed side of the “u” shaped clip has a bevelled end.

18. A clip according to claim 1, wherein the clip is made of a polypropylene that is firm but has a capability of some flexibility.

19. A clip according to claim 18, wherein the clip is molded in a single piece.
